(19) United States
(12) Patent Application Publication
(10) Pub. No.: US 2025/0037648 A1
(43) Pub. Date: Jan. 30, 2025

(54) Systems and Methods for Providing Fine-Grained Arbitrary Presentation Time for Electronic Displays

(71) Applicant: Apple Inc., Cupertino, CA (US)

(72) Inventors: Jie Won Ryu, San Jose, CA (US); Myungjoon Choi, San Diego, CA (US); Kevin W. Sliech, San Francisco, CA (US); Ju Hyung Nam, Cupertino, CA (US); Hyunwoo Nho, Palo Alto, CA (US); Qiuyao Zhu, Milpitas, CA (US)

(21) Appl. No.: 18/784,592

(22) Filed: Jul. 25, 2024

Related U.S. Application Data
(60) Provisional application No. 63/515,833, filed on Jul. 26, 2023.

(51) Int. Cl. G09G 3/32

(52) U.S. Cl. CPC G09G 3/32; G09G 2310/08; G09G 2320/0247; G09G 2340/0435

(57) ABSTRACT

Electronic devices and displays are provided for reducing or eliminating image artifacts due to delayed or dropped image frames. Such an electronic display may include an electronic display panel to display an image frame and display driver circuitry (e.g., a timing controller (TCON)). The display driver circuitry may program display pixels of the display panel to display the image frame over a series of subframes having time quanta higher than a maximum frame rate of the electronic display.

### CROSS-REFERENCE TO RELATED APPLICATIONS

This application claims priority to U.S. Provisional Application No. 63/515,833, filed Jul. 26, 2023, which is incorporated herein by reference in its entirety for all purposes.

### SUMMARY

This disclosure relates to methods for improving front-of-screen performance by providing fine-grained arbitrary presentation time to an electronic display.

A summary of certain embodiments disclosed herein is set forth below. It should be understood that these aspects are presented to provide the reader with a brief summary of these certain embodiments and that these aspects are not intended to limit the scope of this disclosure.

Electronic displays may be found in numerous electronic devices, from mobile phones to computers, televisions, automobile dashboards, and augmented reality or virtual reality glasses, to name just a few. Electronic displays with self-emissive display pixels produce their own light. Self-emissive display pixels may include any suitable light-emissive elements, including light-emitting diodes (LEDs) such as organic light-emitting diodes (OLEDs) or micro-light-emitting diodes (μLEDs). By causing different display pixels to emit different amounts of light, individual display pixels of an electronic display may collectively produce images.

Some electronic displays may display frames of image data using an arbitrary presentation time (APT) scheme, in which the frames of image data may be presented on the electronic display at an arbitrary frame rate. The electronic display may initiate the display of the image frames according to defined quanta of time, such that a single image frame may span an arbitrary integer number of quanta. The quanta may represent the highest frame rate that could be displayed on the electronic display. For example, when the highest frame rate of the electronic display is 240 Hertz (Hz), the frame quanta of the electronic display may be 240 Hz (4.167 milliseconds (ms)). Such an electronic display may support any arbitrary frame rate that is an integer divisor of the highest frame rate.

Image frames may be generated by processing circuitry and provided to the electronic display. Although the processing circuitry may generate (e.g., render) image frames with a particular frame rate, some image frames may take more time to generate than others. As a result, in certain cases an image frame may take too long to generate, and consequently may not reach the electronic display in time to be displayed within the quanta corresponding to the particular frame rate. This may result in the frame being dropped (e.g., not displayed) or delayed (e.g., displayed later than expected or intended) in favor of a subsequent image frame. As a consequence, a viewer may perceive undesirable front-of-screen image artifacts such as judder or flickering, which may negatively impact user experience.

To reduce or prevent dropped or delayed frames and subsequent front-of-screen image artifacts such as judder or flickering, a display driver of the electronic display may program display pixels of the display panel to display the image frame over a series of subframes having time quanta that is finer-grained than the maximum frame rate of the electronic display. For example, the frame quanta of the electronic display may occur at 960 Hz (every 1.042 ms), while the maximum frame rate may be lower. Consequently, even if a frame arrives later than a target frame rate, the frame may still be displayed or at least partially displayed on the electronic display. This reduces or eliminates dropped and delayed frames, which may improve user experience.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device having an electronic display, in accordance with an embodiment;

FIG. 2 is an example of the electronic device in the form of a handheld device, in accordance with an embodiment;

FIG. 3 is an example of the electronic device in the form of a tablet device, in accordance with an embodiment;

FIG. 4 is an example of the electronic device in the form of a notebook computer, in accordance with an embodiment;

FIG. 5 is an example of the electronic device in the form of a wearable device, in accordance with an embodiment;

FIG. 6 is a block diagram of the electronic display, in accordance with an embodiment;

FIG. 7 is a timing diagram illustrating how an image frame may be delayed due to GPU rendering;

FIG. 8 is a timing diagram illustrating how increasing the quanta frequency may reduce or eliminate image artifacts due to delayed presentation of an image frame;

FIG. 9 is a set of plots illustrating the emission output of the display when the quanta frequency is matched to emission frequency and anode reset frequency of the display pixels and the emission output of the display when the quanta frequency does not match the emission frequency and/or anode reset frequency of the display pixels;

FIG. 10 is a plot illustrating the emission output of the display when the quanta frequency is matched to the emission frequency and the anode reset frequency of the display pixels at a rate higher than a maximum frame rate of the electronic display;

FIG. 11 includes signal timing diagrams illustrating control signals provided during a programming frame and a non-programming frame, respectively, having an adjusted timing scheme to compensate for increased power consumption due to higher quanta frequencies, emission frequencies, and/or anode reset frequencies, in accordance with an embodiment;

FIG. 12 includes a set of timing diagrams of emission signals that may be adjusted to offset duty cycle reduction and loss of luminance due to higher quanta frequencies, emission frequencies, and/or anode reset frequencies, in accordance with an embodiment; and

FIG. 13 is a set of plots illustrating adjustments to anode reset voltage to reduce voltage-to-luminance sensitivity due to higher quanta frequencies, emission frequencies, and/or anode reset frequencies, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Some electronic displays may display frames of image data using an arbitrary presentation time (APT) scheme, in which the frames of image data may be presented on the electronic display at an arbitrary frame rate. The electronic display may initiate the display of the image frames according to defined quanta of time, such that a single image frame may span an arbitrary integer number of quanta. In contrast to certain previous electronic displays, in which the quanta may represent the highest frame rate that could be displayed on the electronic display (e.g., when the highest frame rate of the electronic display is 240 Hertz (Hz), the frame quanta of the electronic display may be 240 Hz), it has been discovered that using quanta that are higher than (e.g., 1.5×, 2×, 3×, 4× or more) the maximum frame rate may provide better front-of-screen performance. Indeed, image artifacts such as flicker or judder due to delayed or dropped image frames may be reduced or eliminated.

Image frames may be generated by processing circuitry and provided to the electronic display. Although the processing circuitry may generate (e.g., render) image frames with a particular frame rate, some image frames may take more time to generate than others. As a result, in certain cases an image frame may take too long to generate, and consequently may not reach the electronic display in time to be displayed within the quanta when the quanta correspond exactly to that particular frame rate. This may result in the frame being delayed (e.g., presented later) or dropped (e.g., not displayed) in favor of a subsequent image frame. As a consequence, a viewer may perceive undesirable front-of-screen image artifacts such as judder or flickering, which may negatively impact user experience.

To reduce or prevent delayed or dropped frames and subsequent front-of-screen image artifacts such as judder or flickering, a display driver of the electronic display may program display pixels of the display panel to display the image frame over a series of subframes having time quanta that is finer-grained than the maximum frame rate of the electronic display. For example, the frame quanta of the electronic display may occur at 960 Hz (every 1.042 ms), while the maximum frame rate may be lower (e.g., 80 Hz, 240 Hz, 480 Hz, and so on). Consequently, even if a frame arrives later than a target frame rate, the frame may still be displayed or at least partially displayed on the electronic display. This reduces or eliminates delayed frames and dropped frames, which may improve user experience. It should be noted that, in some embodiments, it may be desirable and beneficial to match the quanta frequency to the emission frequency and/or anode reset frequency. For example, the quanta frequency may be equal to the emission frequency and/or anode reset frequency, or may be a divisor or multiple of the emission frequency and/or anode reset frequency.

However, increasing the frame quanta to such a high frequency may have associated drawbacks that, in some cases may prohibit such an increase in the frame quanta. In some cases, increasing the frame quanta may result in greater power consumption (e.g., due to increased toggling), emission duty cycle reduction and loss of luminance due to higher emission frequency, increased voltage-to-luminance sensitivity, and so on. In embodiments of the present disclosure, the increased power consumption may be mitigated or offset by adjusting (e.g., reducing and/or merging) at least a portion of anode reset and/or emission toggling. To prevent the adjusted anode reset and/or emission toggling from affecting the front-of-screen, the toggling may be adjusted during a non-programming frame. In other embodiments, to mitigate or prevent the duty cycle reduction, the emission-off time of emission pulses may be reduced, such that the duty cycle is increased and any low-luminance front-of-screen issues are reduced or eliminated. In yet other embodiments, the increased voltage-to-luminance sensitivity may be mitigated or offset by adjusting anode reset voltages at higher anode reset/emission frequencies.

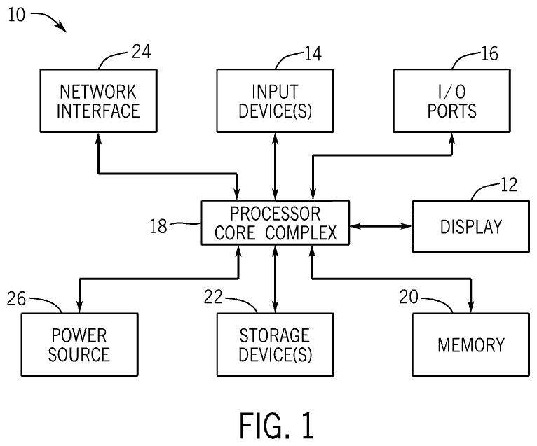

With this in mind, an example of an electronic device 10, which includes an electronic display 12 that may benefit from these features, is shown in FIG. 1. FIG. 1 is a schematic block diagram of the electronic device 10. The electronic device 10 may be any suitable electronic device, such as a computer, a mobile (e.g., portable) phone, a portable media device, a tablet device, a television, a handheld game platform, a personal data organizer, a virtual-reality headset, a mixed-reality headset, a wearable device, a watch, a vehicle dashboard, and/or the like. Thus, it should be noted that FIG. 1 is merely one example of a particular implementation and is intended to illustrate the types of components that may be present in an electronic device 10.

In addition to the electronic display 12, as depicted, the electronic device 10 includes one or more input devices 14, one or more input/output (I/O) ports 16, a processor core complex 18 having one or more processors or processor cores and/or image processing circuitry, memory 20, one or more storage devices 22, a network interface 24, and a power supply 26. The various components described in FIG. 1 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components. For example, the memory 20 and the storage devices 22 may be included in a single component. Additionally or alternatively, image processing circuitry of the processor core complex 18 may be disposed as a separate module or may be disposed within the electronic display 12.

The processor core complex 18 is operably coupled with the memory 20 and the storage device 22. As such, the processor core complex 18 may execute instructions stored in memory 20 and/or a storage device 22 to perform operations, such as generating or processing image data. The processor core complex 18 may include one or more microprocessors, one or more application specific processors (ASICs), one or more field programmable logic arrays (FPGAs), or any combination thereof.

In addition to instructions, the memory 20 and/or the storage device 22 may store data, such as image data. Thus, the memory 20 and/or the storage device 22 may include one or more tangible, non-transitory, computer-readable media that store instructions executable by processing circuitry, such as the processor core complex 18, and/or data to be processed by the processing circuitry. For example, the memory 20 may include random access memory (RAM) and the storage device 22 may include read only memory (ROM), rewritable non-volatile memory, such as flash memory, hard drives, optical discs, and/or the like.

The network interface 24 may enable the electronic device 10 to communicate with a communication network and/or another electronic device 10. For example, the network interface 24 may connect the electronic device 10 to a personal area network (PAN), such as a Bluetooth network, a local area network (LAN), such as an 802.11x Wi-Fi network, and/or a wide area network (WAN), such as a fourth-generation wireless network (4G), LTE, or fifth-generation wireless network (5G), or the like. In other words, the network interface 24 may enable the electronic device 10 to transmit data (e.g., image data) to a communication network and/or receive data from the communication network.

The power supply 26 may provide electrical power to operate the processor core complex 18 and/or other components in the electronic device 10, for example, via one or more power supply rails. Thus, the power supply 26 may include any suitable source of electrical power, such as a rechargeable lithium polymer (Li-poly) battery and/or an alternating current (AC) power converter. A power management integrated circuit (PMIC) may control the provision and generation of electrical power to the various components of the electronic device 10.

The I/O ports 16 may enable the electronic device 10 to interface with another electronic device 10. For example, a portable storage device may be connected to an I/O port 16, thereby enabling the electronic device 10 to communicate data, such as image data, with the portable storage device.

The input devices 14 may enable a user to interact with the electronic device 10. For example, the input devices 14 may include one or more buttons, one or more keyboards, one or more mice, one or more trackpads, and/or the like. Additionally, the input devices 14 may include touch sensing components implemented in the electronic display 12, as described further herein. The touch sensing components may receive user inputs by detecting occurrence and/or position of an object contacting the display surface of the electronic display 12.

In addition to enabling user inputs, the electronic display 12 may provide visual representations of information by displaying one or more images (e.g., image frames or pictures). For example, the electronic display 12 may display a graphical user interface (GUI) of an operating system, an application interface, text, a still image, or video content. To facilitate displaying images, the electronic display 12 may include a display panel with one or more display pixels. The display pixels may represent sub-pixels that each control a luminance of one color component (e.g., red, green, or blue for a red-green-blue (RGB) pixel arrangement).

The electronic display 12 may display an image by controlling the luminance of its display pixels based at least in part image data associated with corresponding image pixels in image data. In some embodiments, the image data may be generated by an image source, such as the processor core complex 18, a graphics processing unit (GPU), an image sensor, and/or memory 20 or storage devices 22. Additionally, in some embodiments, image data may be received from another electronic device 10, for example, via the network interface 24 and/or an I/O port 16.

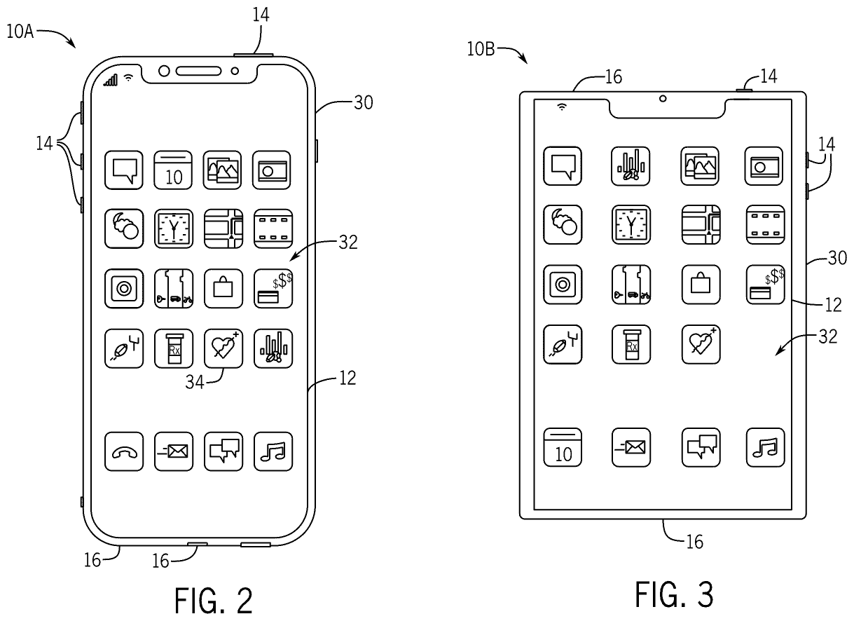

One example of the electronic device 10, specifically a handheld device 10A, is shown in FIG. 2. FIG. 2 is a front view of the handheld device 10A representing an example of the electronic device 10. The handheld device 10A may be a portable phone, a media player, a personal data organizer, a handheld game platform, and/or the like. For example, the handheld device 10A may be a smart phone, such as any iPhone® model available from Apple Inc.

The handheld device 10A includes an enclosure 30 (e.g., housing). The enclosure 30 may protect interior components from physical damage and/or shield them from electromagnetic interference. In the depicted embodiment, the electronic display 12 is displaying a graphical user interface (GUI) 32 having an array of icons 34. By way of example, when an icon 34 is selected either by an input device 14 or a touch sensing component of the electronic display 12, an application program may launch.

Input devices 14 may be provided through the enclosure 30. As described above, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. The I/O ports 16 also open through the enclosure 30. The I/O ports 16 may include, for example, a Lightning® or Universal Serial Bus (USB) port.

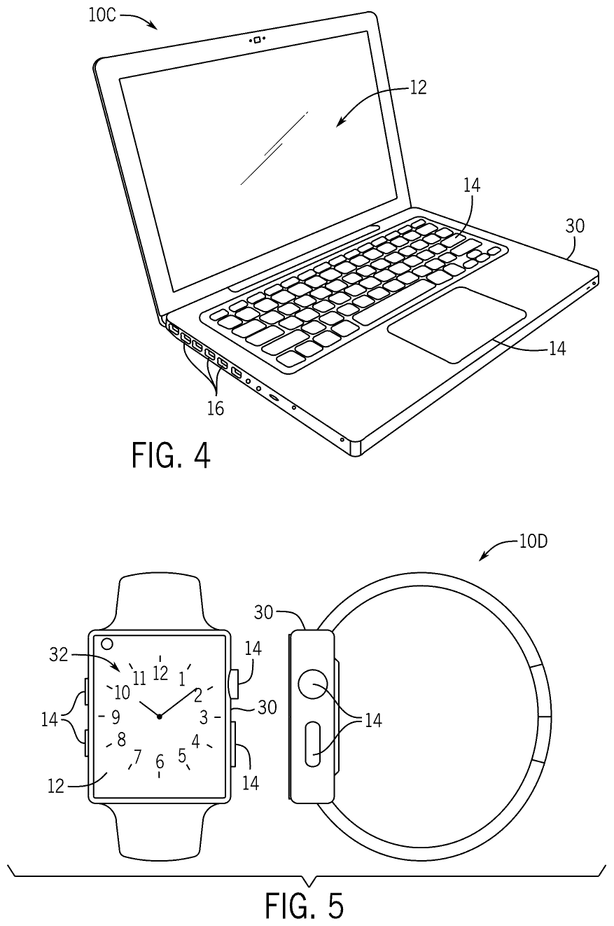

The electronic device 10 may take the form of a tablet device 10B, as shown in FIG. 3. FIG. 3 is a front view of the tablet device 10B representing an example of the electronic device 10. By way of example, the tablet device 10B may be any iPad® model available from Apple Inc. A further example of a suitable electronic device 10, specifically a computer 10C, is shown in FIG. 4. FIG. 4 is a front view of the computer 10C representing an example of the electronic device 10. By way of example, the computer 10C may be any MacBook® or iMac® model available from Apple Inc. Another example of a suitable electronic device 10, specifically a watch 10D, is shown in FIG. 5. FIG. 5 are front and side views of the watch 10D representing an example of the electronic device. By way of example, the watch 10D may be any Apple Watch® model available from Apple Inc. As depicted, the tablet device 10B, the computer 10C, and the watch 10D all include respective electronic displays 12, input devices 14, I/O ports 16, and enclosures 30.

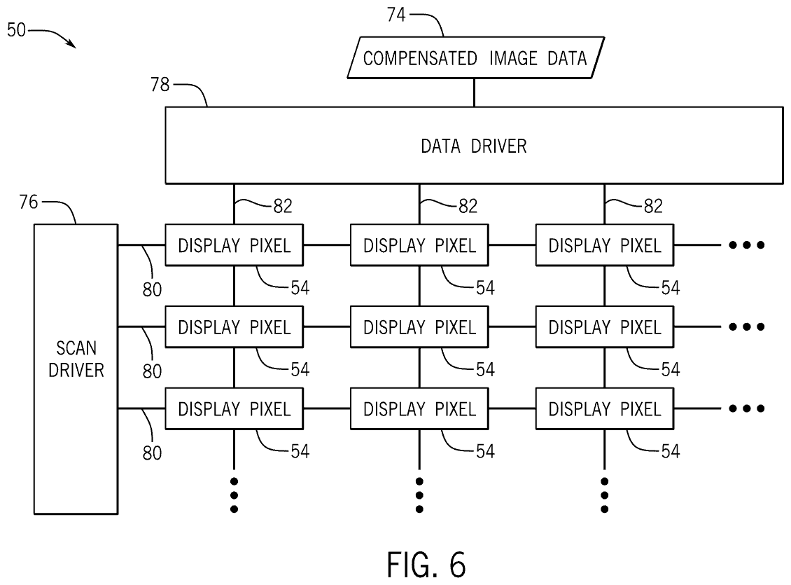

Describing now the display pixel array 50, FIG. 6 is a block diagram of the display pixel array 50 of the electronic display 12. It should be understood that, in an actual implementation, additional or fewer components may be included in the display pixel array 50.

The electronic display 12 may receive compensated image data 74 for presentation on the electronic display 12. The electronic display 12 includes display driver circuitry that includes scan driver circuitry 76 and data driver circuitry 78. The display driver circuitry controls programming the compensated image data 74 into the display pixels 54 for presentation of an image frame via light emitted according to each respective bit of compensated image data 74 programmed into one or more of the display pixels 54.

The display pixels 54 may each include one or more self-emissive elements, such as a light-emitting diodes (LEDs) (e.g., organic light emitting diodes (OLEDs) or micro-LEDs (μLEDs)), however other pixels may be used with the systems and methods described herein including but not limited to liquid-crystal devices (LCDs), digital mirror devices (DMD), or the like, and include use of displays that use different driving methods than those described herein, including partial image frame presentation modes, variable refresh rate modes, or the like.

Different display pixels 54 may emit different colors. For example, some of the display pixels 54 may emit red light, some may emit green light, and some may emit blue light. Thus, the display pixels 54 may be driven to emit light at different brightness levels to cause a user viewing the electronic display 12 to perceive an image formed from different colors of light. The display pixels 54 may also correspond to hue and/or luminance levels of a color to be emitted and/or to alternative color combinations, such as combinations that use red (R), green (G), blue (B), or others.

The scan driver circuitry 76 may provide scan signals (e.g., pixel reset, data enable, on-bias stress) on scan lines 80 to control the display pixels 54 by row. For example, the scan driver circuitry 76 may cause a row of the display pixels 54 to become enabled to receive a portion of the compensated image data 74 from data lines 82 from the data driver circuitry 78. In this way, an image frame of the compensated image data 74 may be programmed onto the display pixels 54 row by row. Other examples of the electronic display 12 may program the display pixels 54 in groups other than by row.

The display 12 may display frames of image data using an arbitrary presentation time (APT) scheme, in which the frames of image data may be presented on the display 12 at an arbitrary frame rate. The display 12 may initiate the display of the image frames according to defined quanta of time, such that a single image frame may span an arbitrary integer number of quanta. For example, the image frame may be presented within one quantum, within two quanta, within 10 quanta, and so on. The quanta may represent the highest frame rate that could be displayed on the display 12. For example, when the highest frame rate of the display 12 is 240 Hertz (Hz), the quanta of the display 12 may be 240 Hz. The display 12 may support any arbitrary frame rate that is an integer divisor of the highest frame rate. In the following description below, quanta may be referred to interchangeably as presentation time quanta, frame quanta, or simply as quanta. The frames of the image data may be displayed on the display 12 via display driver circuitry or a timing controller (TCON) that programs the display pixels 54 of the display panel to display the image frame over the series of subframes having the time quanta.

As previously mentioned, image frames may be generated by processing circuitry (e.g., the processor core complex 18) and provided to the display 12. Although the processing circuitry may generate (e.g., render) image frames with a particular frame rate, some image frames may take more time to generate than others. As a result, in certain cases an image frame may take too long to generate, and consequently may not reach the display 12 in time to be displayed within the quanta corresponding to the particular frame rate. This may result in the frame being dropped (e.g., not displayed) in favor of a subsequent image frame or delayed (e.g., displayed later than expected or intended). As a consequence, a viewer may perceive undesirable front-of-screen image artifacts such as judder or flickering, which may negatively impact user experience.

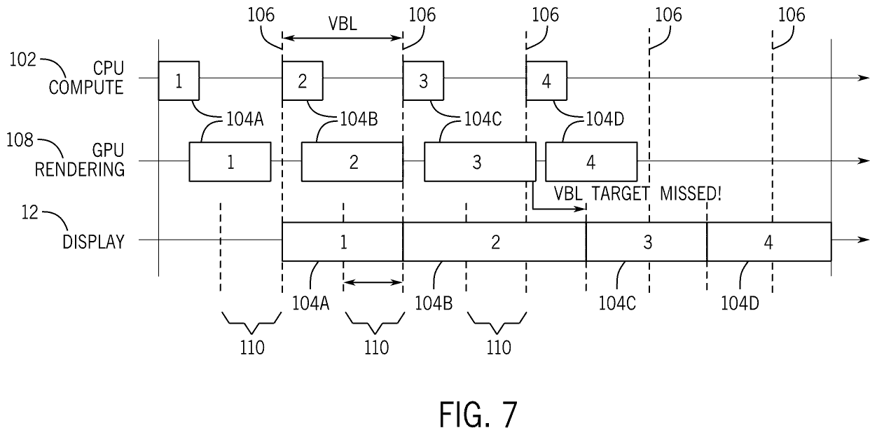

FIG. 7 illustrates how an image frame may be delayed due to GPU rendering. In a CPU computing stage 102, a CPU (e.g., the processor core complex 18) may receive and process image frames 104A, 104B, 104C, and 104D (collectively, the image frames 104). As may be appreciated, in the CPU computing stage 102, the processor core complex 18 may receive and/or process the image frames 104 after a vertical blank (VBL) 106. In a GPU rendering stage 108, the processor core complex 18 may generate or render the image frames 104 for display on the display 12. The display 12 may display the image frames 104 if the image frame 104 is fully rendered by the beginning of the following the vertical blank 106. The submission granularity, or quantum 110, may represent the time in which the image frame 104 is displayed on the display 12. However, if the image frame 104 (e.g., the image frame 104C) is not fully rendered by the time of the occurrence of a subsequent vertical blank 106, the display 12 may repeat or extend the previous image frame 104B until the following quantum 110 and delay the image frames 104C and 104D, or may drop the image frame 104C and show no image frame for that quantum. Extending the image frame 104B and delaying presentation of the image frame 104C—or, alternatively, dropping the image frame 104C entirely-when the display 12 should be displaying the image frame 104C may cause a front-of-screen issue, such as judder or flickering.

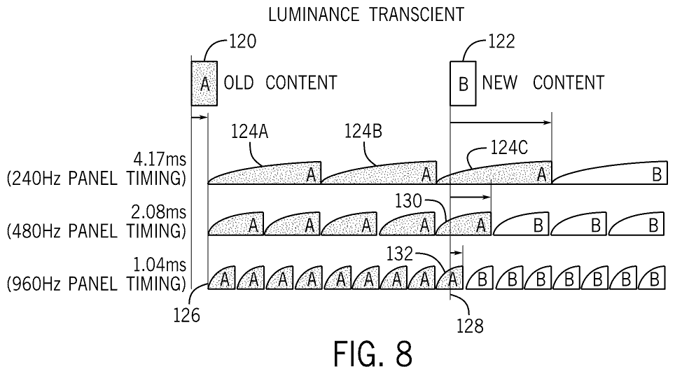

Front-of-screen issues such as those discussed above may be reduced or avoided by decreasing the duration of the individual quanta 110. FIG. 8 illustrates how increasing the quanta frequency (e.g., reducing the time span of individual quanta) may reduce front-of-screen issues such that they are less visible, or even invisible, to a viewer, according to an embodiment of the present disclosure. FIG. 8 illustrates old content image frames 120 and new content image frames 122 under various quanta frequencies of 240 Hz (e.g., each quantum spanning 4.17 milliseconds (ms)), 480 Hz (e.g., each quantum spanning 2.08 ms), and 960 Hz (e.g., each quantum spanning 1.04 ms). At 240 Hz, the old content 120 may span quanta 124A, 124B, and 124C, each spanning a period of 4.17 ms. The old content 120 is intended to begin displaying at time 126, and the new content 122 is intended to begin displaying at time 128. It may be observed that the old content frame at quantum 124C is being displayed by the display 12 when new content frame 122 should be displayed (e.g., past the time 128). The old content frame being displayed when the new content frame should be displayed at quantum 124C may be due to slow rendering speed, as discussed with respect to FIG. 7.

It may be appreciated from FIG. 8 that a front-of-screen issue resulting from a dropped or extended old content frame may last longer at 240 Hz (e.g., may last 4.17 ms) than it would at 480 Hz (e.g., the front-of-screen issue may last 2.08 ms as illustrated by the quantum 130), and that an issue resulting from the dropped or extended old content frame may last longer at 480 Hz than it would at 960 Hz (e.g., where it may last 1.04 ms as illustrated by the quantum 132). The longer the amount of time the old content frame appears on the display 12, the more severe a front-of-screen issue may be (e.g., extended judder, more flickering). Conversely, the shorter the amount of time the old content frame appears on the display 12, the less severe the front-of-screen issue may be, and the less likely a viewing experience is to be impacted by the front-of-screen issue. In this way, it may be appreciated that a greater quanta frequency may reduce or eliminate front-of-screen issues due to slow image rendering. However, other issues may arise from simply increasing quanta frequency without regard to emission frequency or anode reset frequency of a display pixel 54.

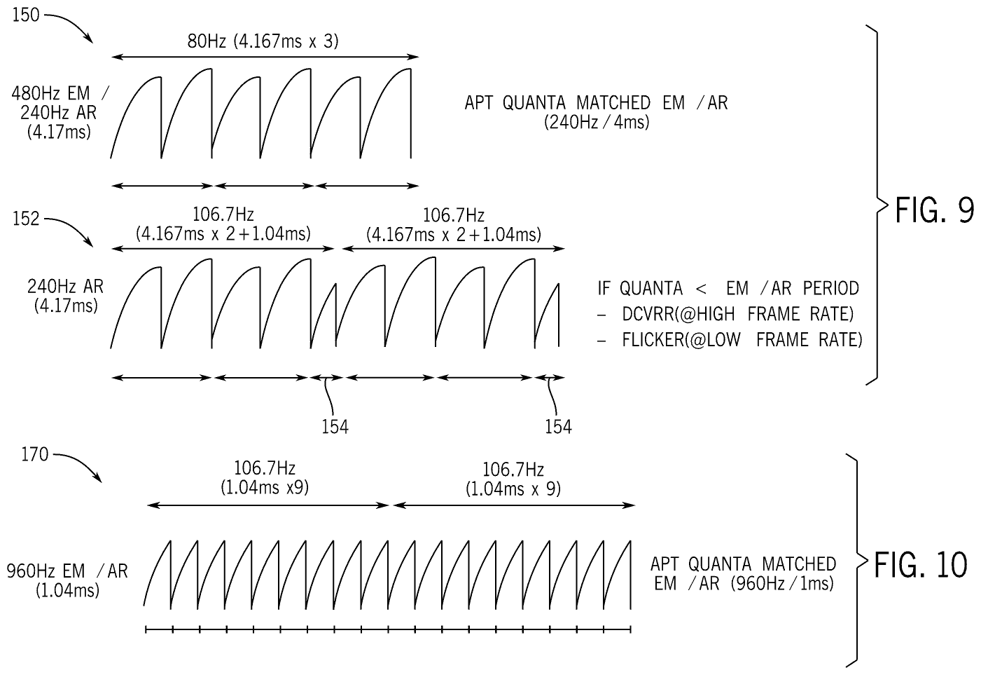

FIG. 9 illustrates the emission output of the display 12 when the quanta frequency is matched to emission frequency and anode reset frequency of the display pixels 54 and the emission output of the display 12 when the quanta frequency does not match the emission frequency and/or anode reset frequency of the display pixels 54. In diagram 150, display pixels 54 may have an emission frequency of 480 Hz, an anode reset frequency of 240 Hz, and a quanta frequency of 240 Hz. As the emission frequency, the anode reset frequency, and the quanta frequency are all matched (e.g., are each divisors or multiples of each other), there are no (or minimal) front-of-screen issues. However, in diagram 152, if the emission frequency and the anode reset frequency are not matched with the quanta frequency (e.g., the quanta frequency is not equal to or a multiple or a divisor of the emission frequency and the anode reset frequency), there may be gaps 154 between emissions and/or anode resets of the display pixels 54 that may cause front-of-screen issues.

FIG. 10 illustrates the emission output of the display 12 when the quanta frequency is matched to the emission frequency and the anode reset frequency of the display pixels 54, wherein the quanta frequency, the emission frequency, and the anode reset frequency are 960 Hz, according to embodiments of the present disclosure. As may be observed in the diagram 170, there are no gaps between the emission frequency and/or the anode reset frequency, and thus there may be no or minimal front-of-screen issues. However, increasing the emission frequency and the anode reset frequency may cause associated problems with the display 12.

For example, the increased quanta frequency, emission frequency, and/or anode reset frequency may result in greater power consumption due to greater toggling frequency, reduced emission duty cycle, loss of luminance, and/or increased voltage-to-luminance sensitivity.

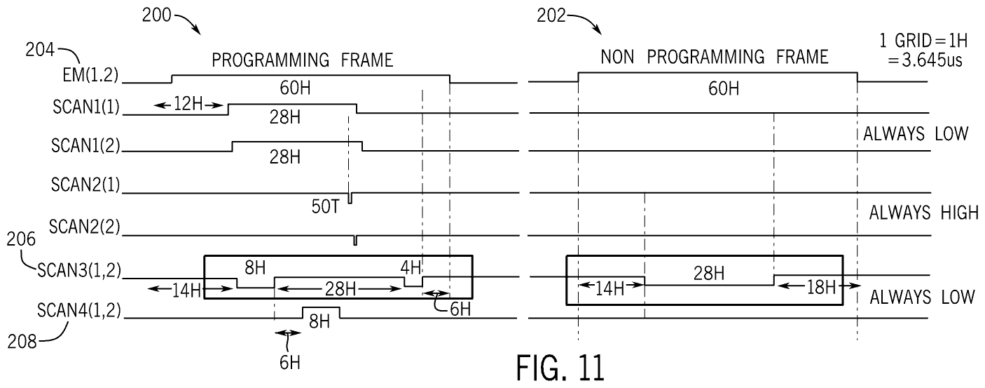

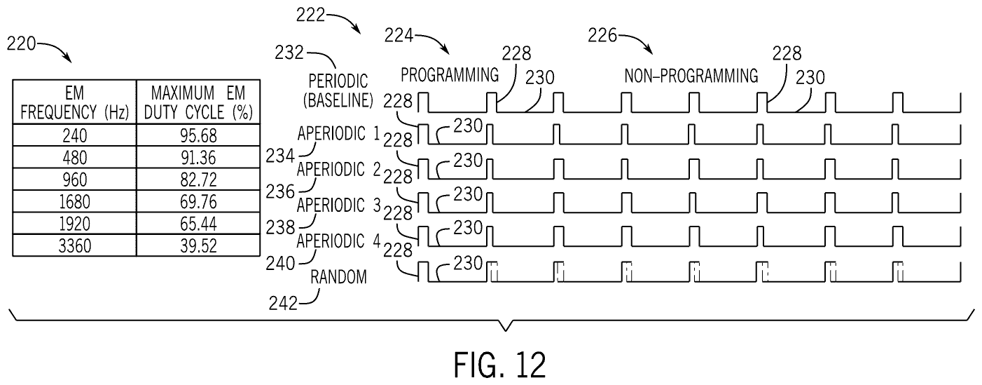

To offset the greater power consumption due to the greater toggling frequency, anode reset toggling and/or emission toggling may be reduced and merged, as will be described in FIG. 11. FIG. 11 includes a timing diagram illustrating a programming frame and a timing diagram illustrating a non-programming frame having an adjusted timing scheme to compensate for increased power consumption, according to embodiments of the present disclosure. A programming frame timing diagram 200 and a non-programming frame timing diagram 202 illustrate the on/off states of a set of signals, including an emission signal 204, an anode reset signal 206, and a data signal 208. To offset the increased power consumption due to the increased quanta frequency, emission frequency, and/or anode reset frequency, the toggling of the anode reset signal 206 may be reduced. However, adjusting the toggling of the anode reset signal 206 during a programming frame may result in additional front-of-screen issues. Therefore, the toggling of the anode reset signal 206 may be reduced during the non-programming frame. As may be observed, the number of anode reset toggles is reduced from two toggles in the programming frame to one toggle in the non-programming frame. In this manner, reducing the toggle frequency of the emission signal 204 and/or the anode reset signal 206 offsets the increased power consumption due to the increased quanta frequency, emission frequency, and/or anode reset frequency.

FIG. 12 illustrates adjustments to emission off duration that may be applied to an emission signal to offset duty cycle reduction and loss of luminance due to higher emission frequencies, according to embodiments of the present disclosure. Table 220 illustrates how increasing emission frequency corresponds to reduced maximum pixel emission duty cycle and thus lower luminance. To offset such a reduction in duty cycle, pulse widths of pixel emission pulses may be adjusted. To adjust the pulse width of the pixel emission pulses, an emission off duration may be reduced, increasing on durations of pixel emissions, as may be observed from timing diagram 222. However, adjusting emission off durations during a programming frame 224 may cause additional front-of-screen issues. Accordingly, in some embodiments, the emission off durations may be adjusted during a non-programming frame 226.

The timing diagram 222 includes various emission profiles including off emissions 228 and on emissions 230. To offset the duty cycle reduction and loss of luminance, the off emissions 228 may be reduced (e.g., the on emissions 230 may be increased). To ensure that the emission adjustments do not cause additional front-of-screen issues, multiple asymmetrical emission adjustments may be made during the non-programming frame 226. The emissions adjustments may be asymmetrical to prevent additional front-of-screen issues from some subframes being consistently lighter or consistently darker than other subframes. Emission profile 232 represents a baseline (e.g., unadjusted) emission profile. Without applying other emissions profiles, the emission profile 232 may cause the display 12 to display with a lower luminance than desired due to the reduced emission signal duty cycle at higher frequencies.

Emission profile 234 illustrates an adjusted emission profile wherein the off emissions 228 in the non-programming frame 226 are reduced to cause an overall increase in the duty cycle of the non-programming frame 226. Emission profile 236 illustrates an adjusted emission profile wherein every other off emission 228 is reduced. Emission profile 238 illustrates an adjusted emission profile wherein every third off emission 228 is reduced. Emission profile 240 illustrates an adjusted emission profile wherein every fourth off emission 228 is reduced. Emission profile 242 illustrates an adjusted emission profile wherein a randomized selection of off emissions 228 are selected to be reduced. With respect to the emission profile 242, the randomly selected off emissions 228 may be selected via a weighted random selection. The emissions profiles 234-242 may be applied to different rows of the display pixels 54 for a single frame, or a single emission profile may be deployed for all display pixels 54 involved in displaying a frame, and each subsequent emission profile may be sequentially deployed to all display pixels 54 for each subsequent image frame. In either case, the emission profiles 234-242 may increase the luminance of the display 12 while averaging out the luminance increase across the display 12 to reduce or eliminate front-of-screen issues.

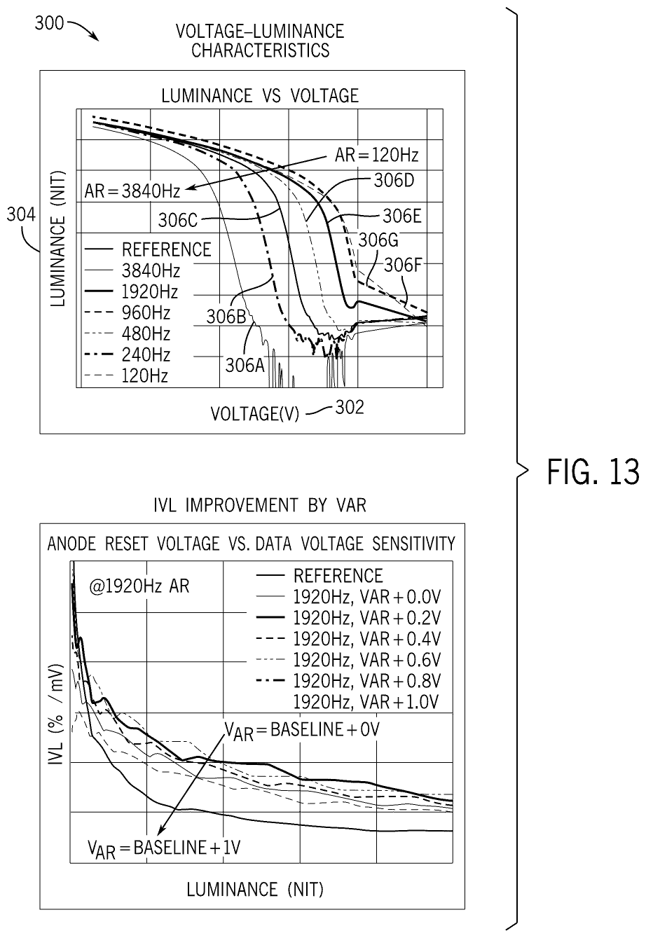

As previously mentioned, the increased quanta frequency, emission frequency, and/or anode reset frequency may result in increased voltage-to-luminance sensitivity. That is, the display pixels 54 may exhibit a greater luminance error for the same given amount of voltage noise and distortion at greater quanta frequency, emission frequency, and/or anode reset frequency. FIG. 13 illustrates adjustments to anode reset voltage to reduce the voltage-to-luminance sensitivity, according to embodiments of the present disclosure. FIG. 13 includes a plot 300 illustrating voltage-luminance characteristics at various anode reset frequencies. The plot 300 includes an x-axis 302 representing voltage in volts (V) and a y-axis 304 representing luminance in nits.

As may be observed from the curves 306A (e.g., representing anode reset frequency of 3840 Hz), 306B (e.g., representing anode reset frequency of 1920 Hz), 306C (e.g., representing anode reset frequency of 960 Hz), 306D (e.g., representing anode reset frequency of 480 Hz), 306E (e.g., representing anode reset frequency of 240 Hz), 306F (e.g., representing anode reset frequency of 120 Hz), and 306G (e.g., e.g., representing a reference anode reset frequency) of the plot 300, the luminance instability increases as the anode reset frequency increases. That is, the luminance fluctuates more significantly for the curve 306A than it fluctuates for the curve 306F. To offset this increase in luminance fluctuations at higher frequencies, the anode reset voltage may be adjusted (e.g., increased) or varied correspondingly to the increased anode reset frequency, as may be observed from the plot 310, which illustrates current-voltage level (IVL) improvement as a function of increased anode reset voltage (VAR). The plot incudes an x-axis 312 representing luminance in nits and a y-axis 314 representing IVL in % per millivolt (%/mV). The plot 310 shows a desired reduction in IVL at a relatively high frequency (e.g., 1920 Hz) as the anode reset voltage is increased. Accordingly, the anode reset voltage may increase as the anode reset frequency increases. For example, the anode reset voltage may increase proportionally to the anode reset frequency, or the anode reset voltage may increase asymmetrically. The anode reset voltage increase may include an increase of 0.1 V, 0.2 V, 0.4 V, 0.6 V, 0.8 V, and 1.0 V above a baseline anode reset voltage. It should be noted that while 0.1 V-1.0 V are shown, the voltage increase may include any appropriate voltage increase, such a 0.25 V or more, 0.75 V or more, 1.2 V or more, 2.0 V or more, 5.0 V or more, and so on. Accordingly, at lesser anode reset frequencies, a smaller anode reset voltage adjustment may be provided, while at greater anode reset frequencies, a greater anode reset voltage adjustment may be provided.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electronic display, comprising:
an electronic display panel comprising a plurality of display pixels configured to display an image frame; and
display driver circuitry configured to:
program the plurality of display pixels to display the image frame over a series of subframes having time quanta higher than a maximum frame rate of the electronic display, wherein the series of subframes comprises:
a programming subframe comprising a first plurality of emission pulses; and
a plurality of non-programming subframes, comprising a second plurality of emission pulses fewer than the first plurality of emission pulses.

2. The electronic display of claim 1, wherein every other pulse of the first plurality of emission pulses comprises a reduced emission off pulse.

3. The electronic display of claim 1, wherein every third pulse of the first plurality of emission pulses comprises a reduced emission off pulse.

4. The electronic display of claim 1, wherein every fourth pulse of the first plurality of emission pulses comprises a reduced emission off pulse.

5. The electronic display of claim 1, wherein a plurality of randomly selected pulses of the first plurality of emission pulses comprises a reduced emission off pulse.

6. The electronic display of claim 5, wherein the plurality of randomly selected pulses is selected via a weighted random selection.

7. The electronic display of claim 1, wherein the time quanta are equal to a divisor of the maximum frame rate.

8. The electronic display of claim 1, wherein the time quanta are equal to a multiple of the maximum frame rate.

9. An electronic device, comprising:
an electronic display comprising a plurality of display pixels configured to display an image frame; and
display driver circuitry configured to:
program the plurality of display pixels to display the image frame over a series of subframes having time quanta based on a maximum frame rate of the electronic display, wherein the series of subframes comprises:
a programming subframe; and
a plurality of non-programming subframes, wherein each of the non-programming subframes utilizes fewer toggles than the programming subframe.

10. The electronic device of claim 9, wherein each of the non-programming subframes is configured to utilize fewer emission toggles.

11. The electronic device of claim 9, wherein each of the non-programming subframes is configured to utilize fewer anode reset toggles.

12. The electronic device of claim 11, wherein each of the non-programming subframes is configured to utilize one-half of the anode reset toggles.

13. The electronic device of claim 9, wherein the time quanta are equal to the maximum frame rate.

14. The electronic device of claim 9, wherein the display driver circuitry is configured to program the plurality of display pixels to display the image frame over the series of subframes having the time quanta, the time quanta comprising a rate four times higher than the maximum frame rate.

15. The electronic device of claim 9, wherein the display driver circuitry is configured to program the plurality of display pixels to display the image frame over the series of subframes having the time quanta, the time quanta comprising a rate of 960 Hertz.

16. The electronic device of claim 9, wherein the display driver circuitry is configured to program the plurality of display pixels to display the image frame over the series of subframes having the time quanta higher than the maximum frame rate, the maximum frame rate comprising 240 Hz.

17. An electronic display, comprising:
an electronic display panel comprising a plurality of display pixels configured to display an image frame;
display driver circuitry configured to program the plurality of display pixels to display the image frame over a series of subframes having time quanta based on a maximum frame rate of the electronic display; and
processing circuitry configured to provide an adjusted anode reset voltage that varies based on an anode reset frequency.

18. The electronic display of claim 17, wherein the processing circuitry is configured to increase the adjusted anode reset voltage proportionally to the anode reset frequency.

19. The electronic display of claim 17, wherein the processing circuitry is configured to increase the adjusted anode reset voltage by 1 volt above a baseline voltage.

20. The electronic display of claim 17, wherein the processing circuitry is configured to increase the adjusted anode reset voltage by 1 volt above a baseline voltage based on determining that the anode reset frequency comprises 1920 Hz.
